(19) United States
(12) Patent Application Publication
(10) Pub. No.: US 2010/0177694 A1
(43) Pub. Date: Jul. 15, 2010

(54) APPARATUS AND METHOD FOR TRANSMITTING UPLINK CONTROL INFORMATION

(75) Inventors: Hua-Lung YANG, Taipei City (TW); Chien-Min Lee, Xinzhuang City (TW); Ren-Jr Chen, Sanchong City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/614,091

(22) Filed: Nov. 6, 2009

Related U.S. Application Data
(60) Provisional application No. 61/143,662, filed on Jan. 9, 2009.

(51) Int. Cl. H04W 40/00

(52) U.S. Cl. 370/328

(57) ABSTRACT

A method for a user equipment to transmit uplink control information to a base station, the base station being configured to receive uplink control information on a plurality of groups of subcarriers. The method includes: randomly determining one of the groups of subcarriers; and transmitting uplink control information on the randomly determined group of subcarriers.

### RELATED APPLICATIONS

This application is based upon and claims the benefit of priority from U.S. Provisional Patent Application No. 61/143,662, filed Jan. 9, 2009, the entire contents of which are incorporated herein by reference.

### TECHNICAL FIELD

This disclosure relates to apparatus and method for transmitting uplink control information in a wireless communication system.

### BACKGROUND

Wireless communications operating according to a predetermined standard have gained worldwide popularity. Among different standards, the Long Term Evolution (LTE) standard is a fourth generation of radio technologies designed to increase throughput and link performance of wireless communication systems.

A wireless communication system operating according to the LTE standard typically includes a base station, also known as an eNodeB (eNB), and a plurality of user equipments (UEs). The UEs are each configured to provide uplink control information to the base station on a physical uplink control channel (PUCCH). For example, for traffic data received from the base station, each of the UEs may send to the base station an acknowledgment (ACK) to report that the data is correctly received, or a negative acknowledgment (NACK) to report that the data is not correctly received. Each of the UEs may also send to the base station a channel quality indicator (CQI) to report a measurement of quality of communication channels. Based on the uplink control information, the base station may determine how to schedule further data transmission for each of the UEs.

FIG. 1 is a table 100 showing different PUCCH formats that may be used by a UE, according to the LTE standard. For example, first and second categories of PUCCH formats, i.e., PUCCH format 1/1a/1b and PUCCH format 2/2a/2b, are defined in the LTE standard. For each of the PUCCH formats, the LTE standard specifies a modulation scheme and a number of bits representing uplink control information in a subframe. For example, PUCCH format 1a is used only to send an ACK/NACK, with a binary phase shift keying (BPSK) modulation scheme and 1 bit to represent the ACK/NACK. Also for example, PUCCH format 2a uses 21 bits to send a CQI and an ACK/NACK together, wherein 20 bits represent the CQI with a quadrature phase shift keying (QPSK) modulation scheme and 1 bit represents the ACK/NACK with the BPSK modulation scheme. A UE may use one of the PUCCH formats shown in the table 100 to provide uplink control information to the base station.

According to the LTE standard, the PUCCH occupies a plurality of resource blocks (RBs) located at edges of an uplink bandwidth. For example, the base station and the UEs operating according to the LTE standard typically communicate using multiple subcarriers based on an orthogonal frequency-division multiplexing (OFDM) technique, and a resource block is a representation of ones of the subcarriers and a plurality of times to be allocated as a resource unit for data transmission. A number of the plurality of RBs or the uplink bandwidth for the PUCCH are configured by the base station, and information regarding the PUCCH is then provided by the base station to the UEs.

FIG. 2 illustrates an RB allocation 200 for the PUCCH in an uplink subframe 202, according to the LTE standard. Different uplink subframes including the PUCCH have a similar RB allocation to the RB allocation 200. For example, the subframe 202 includes a first slot 204 and a second slot 206. A plurality of RBs located at edges of an uplink bandwidth 208, which are represented by the small blocks and indexed with m=0, 1, 2, . . . are allocated for the PUCCH. The RBs in the second slot 206 are allocated by performing mirror mapping on the RBs in the first slot 204 according to the index m. In addition, the RBs having the same index m in the first slot 204 and the second slot 206 may carry uplink control information from a same group of UEs. Due to the mirror mapping, frequency diversity may be achieved for the uplink control information from the group of UEs.

According to the LTE standard, for the slot 204 or 206 of the subframe 202, at most one of the RBs allocated for the PUCCH may carry uplink control information with mixed PUCCH formats, and the at most one of the RBs is also known as a mixed-format RB. For example, a first plurality of subcarriers for the mixed-format RB may carry uplink control information with PUCCH format 1/1a/1b, and a second plurality of subcarriers for the mixed-format RB may carry uplink control information with PUCCH format 2/2a/2b.

Remaining ones of the RBs in the slot 204 or 206 may carry uplink control information with either PUCCH format 1/1a/1b or PUCCH format 2/2a/2b. An RB only carrying uplink control information with PUCCH format 1/1a/1b is also known as an RB for PUCCH format 1/1a/1b, and an RB only carrying uplink control information with PUCCH format 2/2a/2b is also known as an RB for PUCCH format 2/2a/2b, in addition, each of the RBs is indexed such that the index m for an RB determines a location of that RB in the uplink bandwidth 208.

FIG. 3 illustrates a method 300 for both the base station and the UEs to index a plurality of RBs allocated for the PUCCH in a first slot of a subframe, when none of the RBs is a mixed-format RB, according to the LTE standard. For example, if a total number of the RBs for PUCCH format 1/1a/1b is denoted as N_{RB}⁽¹⁾ and a total number of the RBs for PUCCH format 2/2a/2b is denoted as N_{RB}⁽²⁾, the RBs for PUCCH format 2/2a/2b are indexed from 0 to N_{RB}⁽²⁾−1, and the RBs for PUCCH format 1/1a/1b are indexed from N_{RB}⁽²⁾ to N_{RB}⁽¹⁾+N_{RB}⁽¹⁾−1, as shown in FIG. 3.

FIG. 4 illustrates a method 400 for both the base station and the UEs to index a plurality of RBs allocated for the PUCCH in a first slot of a subframe, when one of the RBs is a mixed-format RB, according to the LTE standard. For example, if a total number of the RBs for PUCCH format 1/1a/1b is denoted as N_{RB}⁽¹⁾ and a total number of the RBs for PUCCH format 2/2a/2b is denoted as N_{RB}⁽²⁾, the RBs for PUCCH format 2/2a/2b are indexed from 0 to N_{RB}⁽²⁾−1, the mixed-format RB is indexed as N_{RB}⁽²⁾, and the RBs for PUCCH format 1/1a/1b are indexed from N_{RB}⁽²⁾+1 to N_{RB}⁽¹⁾+N_{RB}⁽²⁾, as show in FIG. 4.

Typically, uplink control information from different UEs is multiplexed based on a code division multiplex (CDM) technique. For example, each of the UEs may simultaneously use a cyclic shift (CS) sequence and an orthogonal cover (OC) sequence, or only use a cyclic shift sequence, to perform spreading/scrambling on data bits representing the uplink control information to generate an uplink control signal, and transmits the uplink control signal to the base station on the PUCCH.

To generate the uplink control signal, each of the UEs is assigned a UE-specific resource index by the base station, also known as a higher-layer configured resource index. Based on the resource index, each of the UEs may determine the cyclic shift sequence and/or the orthogonal cover sequence, and also determine an RB allocated for the PUCCH to transmit the uplink control information.

FIG. 5 illustrates a block diagram of a method 500 for each of the UEs to generate an uplink control signal, according to the LTE standard. For uplink control information with PUCCH format 1/1a/1b, data bits representing the uplink control information in a subframe are mapped to a complex-valued signal by performing symbol mapping (502). The complex-valued signal is multiplied with a cyclic shift (CS) sequence (504) and an orthogonal cover (0° C.) sequence (506), e.g., a Walsh sequence, and is then mapped to an RB to generate the uplink control signal (508). For uplink control information with PUCCH format 2/2a/2b, data bits representing the uplink control information in a subframe are scrambled by a UE-specific scrambling sequence (510) and are further mapped to a complex-valued signal by performing symbol mapping (502). The complex-valued signal is multiplied by a cyclic shift sequence (504), and is then mapped to an RB to generate the uplink control signal (508).

As noted above, a UE determines the RB, the cyclic shift sequence, and/or the orthogonal cover sequence based on a UE-specific resource index assigned by the base station. For example, the cyclic shift sequence is determined by selecting, according to the resource index, a cyclic shift sequence from a plurality of cyclic shift sequences (512). For different UEs with different resource indexes, corresponding cyclic shift sequences may be selected. Also for example, the orthogonal cover sequence is determined by selecting, also according to the resource index, an orthogonal cover sequence from a plurality of orthogonal cover sequences (514). For different UEs with different resource indexes, different orthogonal cover sequences may be selected. Further for example, the RB is selected by determining, still according to the resource index, an index of the RB (516).

FIG. 6 illustrates a method 600 for each of the UEs to determine an RB, a cyclic shift sequence, and/or an orthogonal cover sequence to transmit uplink control information for a first slot in a subframe, according to the LTE standard. For example, the determination is based on a lookup table 602. In the lookup table 602, “m” represents indexes of RBs allocated for the PUCCH, “CS” represents indexes of available cyclic shift sequences, and “OC” represents indexes of available orthogonal cover sequences. For example, the lookup table 602 is configured by the base station and provided by the base station to each of the UEs. The base station may assign to each of the UEs a different, i.e., UE-specific, resource index in the lookup table 602.

Accordingly, each of the UEs may determine the RB, the cyclic shift sequence, and/or the orthogonal cover sequence by looking up the assigned resource index in the lookup table 602, and transmit an uplink control signal to the base station based on the determined RB, the determined cyclic shift sequence, and/or the determined orthogonal cover sequence. When the base station receives the uplink control signal from each of the UEs, the base station may recover, also based on the lookup table 602, the control information from the received uplink control signal. It should be understood that the determination of the RB, the cyclic shift sequence, and/or the orthogonal cover sequence may also be performed by calculations based on equations that are known to both the base station and the UEs.

In the illustrated example, it is assumed that the RBs with m=0 and m=1 are RBs for PUCCH format 2/2a/2b; the RB with m=2 is a mixed-format RB; and the RBs with m=3 and m=4 are RBs for PUCCH format 1/1a/1b. In other words, N_{RB}⁽¹⁾=2 and N_{RB}⁽²⁾=2. In addition, N_{CS}⁽¹⁾ is used to denote a number of cyclic shift sequences that are reserved for uplink control information with PUCCH format 1/1a/1b in the mixed-format RB, e.g., N_{CS}⁽¹⁾=6 in FIG. 6. When there is no mixed-format RB, N_{CS}⁽¹⁾=0.

More particularly, in the illustrated example, n_{PUCCH}⁽²⁾, which denotes the resource index for uplink control information with PUCCH format 2/2a/2b, has values from 0 to 27, and n_{PUCCH}⁽¹⁾, which denotes the resource index for uplink control information with PUCCH format 1/1a/1b, has values from 0 to 44. Additionally, Δ_{shift}^{PUCCH}, which is a cell-specific parameter configured by the base station and denotes a minimal cyclic shift spacing of n_{PUCCH}⁽¹⁾ for a given orthogonal cover sequence, is assumed to be two.

According to the LTE standard, a UE transmitting uplink control information with PUCCH format 2/2a/2b uses the resource index n_{PUCCH}⁽²⁾ to determine an PUCCH RB and a cyclic shift sequence for transmitting the uplink control information, by looking up the resource index n_{PUCCH}⁽²⁾ in the lookup table 602. For example, if the UE is assigned with the resource index n_{PUCCH}⁽²⁾=19, the UE selects the cyclic shift sequence with CS=7, and the RB with m=1. Also for example, if the UE is assigned with the resource index n_{PUCCH}⁽²⁾=25, the UE selects the cyclic shift sequence with CS=8, and the RB with m=2.

According to the LTE standard, a UE transmitting uplink control information with PUCCH format 1/1a/1b uses the resource index n_{PUCCH}⁽¹⁾ to determine an RB, a cyclic shift sequence, and an orthogonal cover sequence for transmitting the uplink control information, by looking up the resource index n_{PUCCH}⁽¹⁾ in the lookup table 602. For example, if the UE is assigned with the resource index n_{PUCCH}⁽¹⁾=23, the UE PUCCH selects the RB with m=3, the cyclic shift sequence with CS=4, and the orthogonal cover sequence with OC=2. Also for example, if the UE is assigned with the resource index n_{PUCCH}⁽¹⁾=3, the UE selects the RB with m=2, the cyclic shift sequence with CS=1, and the orthogonal cover sequence with OC=1.

As a result, a group of UEs may transmit uplink control information on a same plurality of subcarriers in the first slot of each of a plurality of subframes, and the group of UEs may also transmit uplink control information on a same plurality of subcarriers in the second slot of each of the plurality of subframes. When communication channels between the base station and the UEs become frequency selective, or a near-far effect exists for the communication system, there may be relatively strong multiple-access interference for the group of UEs. As a result, the base station may not correctly recover uplink control information for the group of UEs.

### SUMMARY

According to a first aspect of the present disclosure, there is provided a method for a user equipment to transmit uplink control information to a base station, the base station being configured to receive uplink control information on a plurality of groups of subcarriers, the method comprising: randomly determining one of the groups of subcarriers; and transmitting uplink control information on the randomly determined group of subcarriers.

According to a second aspect of the present disclosure, there is provided a user equipment to transmit uplink control information to a base station, the base station being configured to receive uplink control information on a plurality of groups of subcarriers, the user equipment comprising: a processor, the processor being configured to randomly determine one of the groups of subcarriers, and transmit uplink control information on the randomly determined group of subcarriers.

According to a third aspect of the present disclosure, there is provided a method for a user equipment to transmit uplink control information to a base station, the method comprising: randomly determining a cyclic shift sequence from a plurality of cyclic shift sequences; and multiplying data bits representing the uplink control information with the randomly selected cyclic shift sequence to generate a signal including the uplink control information.

According to a fourth aspect of the present disclosure, there is provided a user equipment to transmit uplink control information to a base station, the user equipment comprising: a processor, the processor being configured to randomly determine a cyclic shift sequence from a plurality of cyclic shift sequences, and multiply data bits representing the uplink control information with the randomly determined cyclic shift sequence to generate a signal including the uplink control information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a table showing different PUCCH formats that may be used by a UE, according to the LTE standard.

FIG. 2 illustrates an RB allocation for a PUCCH in an uplink subframe, according to the LTE standard.

FIG. 3 illustrates a method for both a base station and UEs to index a plurality of RBs allocated for the PUCCH in a first slot of a subframe, when none of the RBs is a mixed-format RB, according to the LTE standard.

FIG. 4 illustrates a method for both a base station and UEs to index a plurality of RBs allocated for the PUCCH in a first slot of a subframe, when one of the RBs is a mixed-format RB, according to the LTE standard.

FIG. 5 illustrates a block diagram of a method for a UE to generate an uplink control signal, according to the LTE standard.

FIG. 6 illustrates a method for a UE to determine an RB, a cyclic shift sequence, and/or an orthogonal cover sequence to transmit uplink control information for a first slot in a subframe, according to the LTE standard.

FIG. 7 illustrates a method for a UE to transmit uplink control information, according to an exemplary embodiment.

FIG. 8 illustrates a method for a UE to transmit uplink control information, according to an exemplary embodiment.

FIGS. 9-12 illustrate methods for a UE to randomly determine an RB and a cyclic shift sequence for performing ACK/NACK and CQI transmission, according to exemplary embodiments.

FIGS. 13-16 illustrate methods for a UE to randomly determine an RB, a cyclic shift sequence, and an orthogonal cover sequence for performing ACK/NACK transmission, according to exemplary embodiments.

FIG. 17 illustrates a block diagram of a UE, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

In exemplary embodiments, there are provided apparatus and methods for transmitting uplink control information in a wireless communication system. For example, the communication system includes a base station and one or more user equipments (UEs), and is configured to operate according to, e.g., the Long Term Evolution (LTE) standard.

In exemplary embodiments, the UEs are each configured to provide uplink control information to the base station on a physical uplink control channel (PUCCH). For example, for data received from the base station, each of the UEs may send to the base station an acknowledgment (ACK) to report that the data is correctly received, or a negative acknowledgment (NACK) to report that the data is not correctly received. Each of the UEs may also send to the base station a channel quality indicator (CQI) to report a measurement of quality of communication channels.

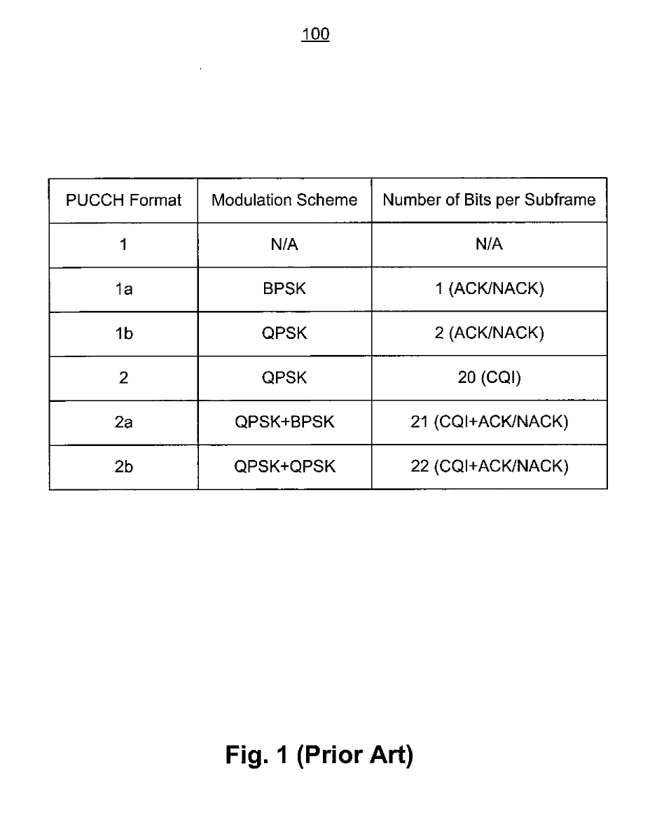

In exemplary embodiments, the UEs may each be configured to perform ACK/NACK and CQI transmission, or ACK/NACK transmission. When a UE performs the ACK/NACK and CQI transmission, the UE simultaneously transmits an ACK/NACK and a CQI together on the PUCCH, e.g., using PUCCH format 2/2a/2b in the LTE standard (FIG. 1). When the UE performs the ACK/NACK transmission, the UE only transmits an ACK/NACK on the PUCCH, e.g., using PUCCH format 1/1a/1b in the LTE standard (FIG. 1).

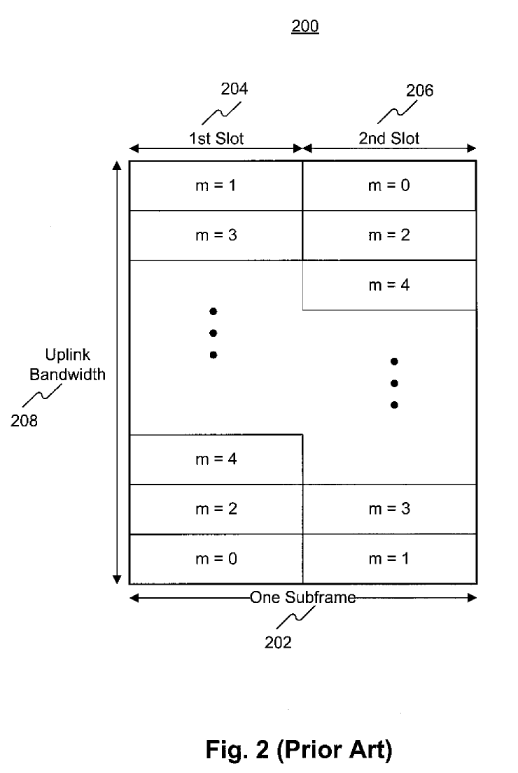

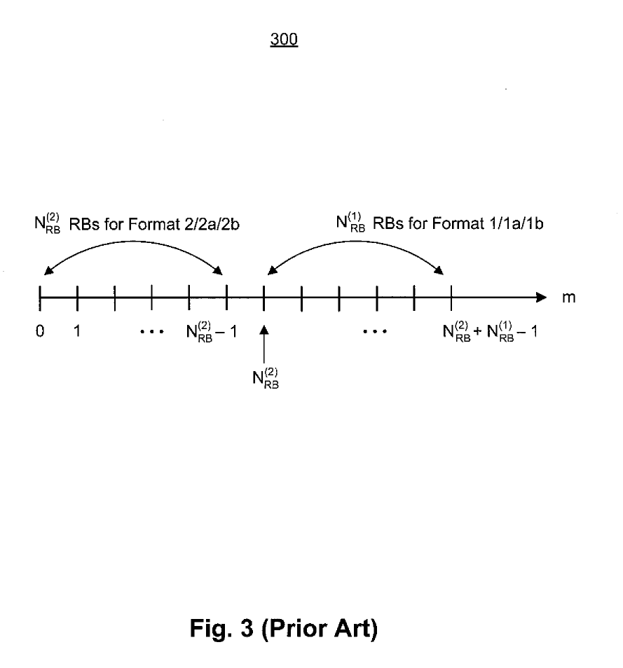

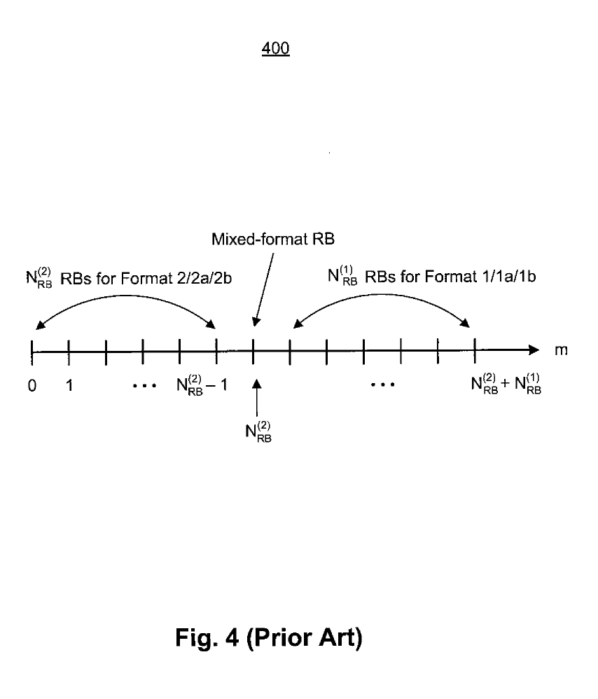

In exemplary embodiments, the base station is configured to receive uplink control information on the PUCCH. The PUCCH may occupy a plurality of resource blocks (RBs) located at edges of an uplink bandwidth in a slot of a subframe. Each of the RBs is allocated and indexed according to, e.g., the methods described above in FIGS. 2-4. For example, the base station and the UEs communicate using multiple subcarriers based on an orthogonal frequency-division multiplexing (OFDM) technique, an RB being a representation of ones of the subcarriers, referred to herein as a group of subcarriers, and a plurality of times to be allocated as a resource unit for data transmission. In other words, the base station receives uplink control information on a plurality of groups of subcarriers. Based on the uplink control information, the base station may determine how to schedule further data transmission for each of the UEs.

In exemplary embodiments, each of the UEs randomly determines one of the RBs allocated for the PUCCH to transmit uplink control information. In other words, each of the UEs randomly determines one of the plurality of groups of subcarriers to transmit the uplink control information.

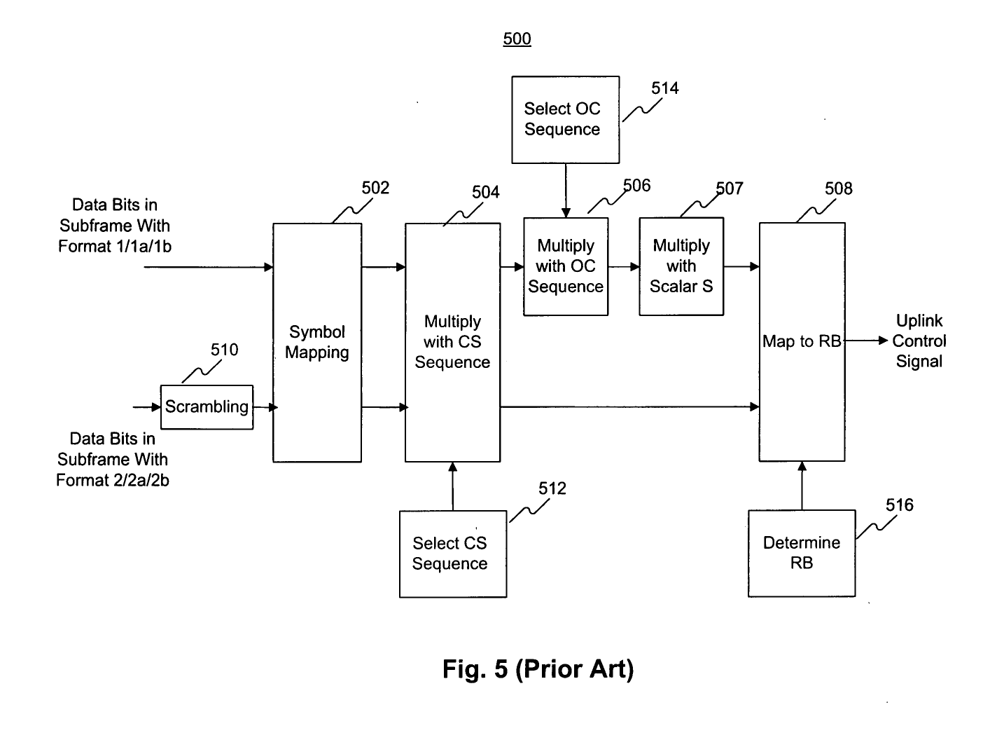

In exemplary embodiments, each of the UEs randomly determines a cyclic shift sequence from a plurality of cyclic shift sequences and/or an orthogonal cover sequence from a plurality of orthogonal cover sequences. Each of the UEs further transmits uplink control information based on the randomly determined cyclic shift sequence and/or the randomly determined orthogonal cover sequence, e.g., using the method 500 (FIG. 5).

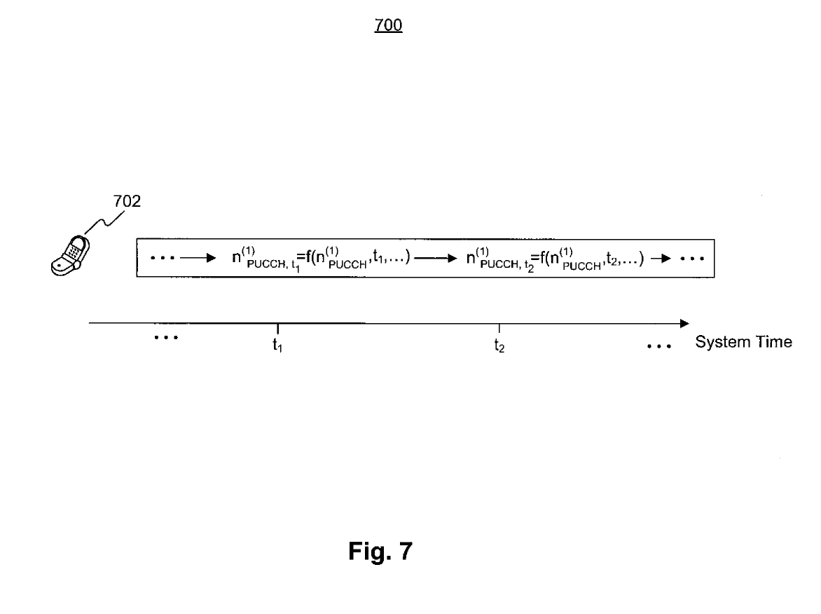

FIG. 7 illustrates a method 700 for a UE 702 to provide uplink control information, according to an exemplary embodiment. For example, the UE 702 is a first one of the UEs in the above-described communication system. Also for example, the UE 702 performs the ACK/NACK transmission to the base station in the communication system.

In exemplary embodiments, the base station assigns to the UE 702 a resource index n_{PUCCH}⁽¹⁾. The UE 702 uses the assigned resource index n_{PUCCH}⁽¹⁾ and a random variable to calculate a virtual resource index based on a function f. For example, the UE 702 may use a system time as the random variable. Also for example, the UE 702 may use cell-specific parameters to calculate the virtual resource index, in addition to using the assigned resource index n_{PUCCH}⁽¹⁾ and the system time.

In exemplary embodiments, because a value of the random variable changes with time, the virtual resource index calculated at different times may have different values. For example, FIG. 7 shows calculation of the virtual resource index at first and second system times t₁ and t₂, where n_{PUCCH,t}_{₁}⁽¹⁾ and n_{PUCCH,t}_{₂}⁽¹⁾ are the values of the virtual resource index calculated at the first and second system times t₁ and t₂, respectively.

In exemplary embodiments, the UE 702 may calculate the virtual resource index periodically or aperiodically. In one exemplary embodiment, the UE 702 calculates the virtual resource index as follows:

virtual resource index=(assigned resource index+system time)mod(Y), equation (1a)

where “mod” denotes a modulo operation, and Y is a total number of the resource indexes for the ACK/NACK transmission that correspond to the RBs having an even-number index or the RBs having an odd-number index, as described below.

In exemplary embodiments, the UE 702 determines an RB from the RBs allocated for the PUCCH, a cyclic shift sequence from the plurality of cyclic shift sequences, and an orthogonal cover sequence from the plurality of cyclic shift sequences, based on the virtual resource index, also as described below. The UE 702 further transmits uplink control information based on the determined RB, the determined cyclic shift sequence, and the determined orthogonal cover sequence, e.g., using the method 500 (FIG. 5). Because the virtual resource index is calculated based on the random variable and has different values at different times, the RB, the cyclic shift sequence, and the orthogonal cover sequence are randomly determined. As a result, multiple-access interference may be randomized and the near-far effect may be reduced between different UEs.

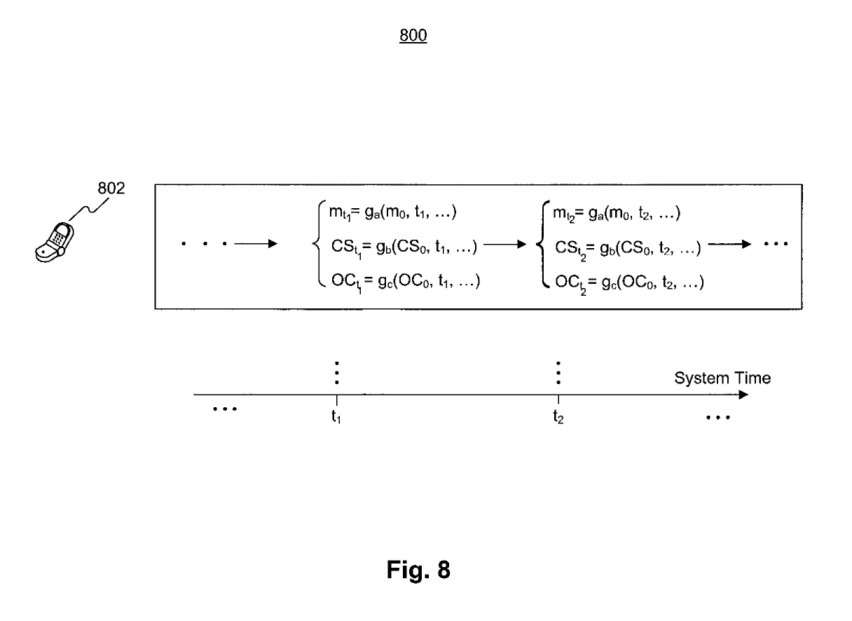

FIG. 8 illustrates a method 800 for a UE 802 to provide uplink control information, according to an exemplary embodiment. For example, the UE 802 is a first one of the UEs in the above-described communication system. Also for example, the UE 802 performs the ACK/NACK transmission to the base station in the communication system.

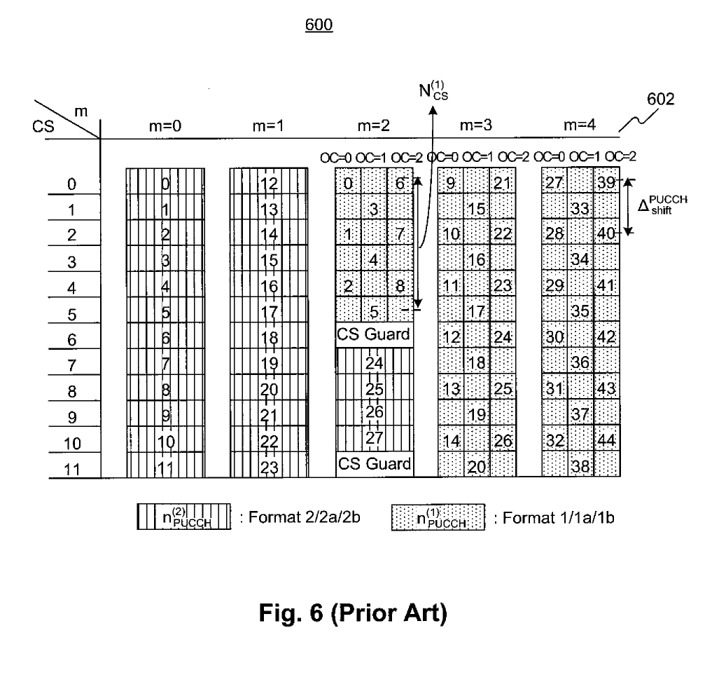

In exemplary embodiments, the base station assigns to the UE 802 a resource index. The UE 802 maps the assigned resource index to an initial RB with an index mₜ_{₀}, an initial cyclic shift sequence with an index CSₜ_{₀}, and an initial orthogonal cover sequence with an index OCₜ_{₀}, similar to the method 600 (FIG. 6). The UE 802 further uses a random variable to determine an RB from the RBs allocated for the PUCCH, a cyclic shift sequence from the plurality of cyclic shift sequences, and an orthogonal cover sequence from the plurality of orthogonal cover sequences, based on the index mₜ_{₀}, the index CSₜ_{₀}, and the index OCₜ_{₀}, respectively. For example, the determination of the RB, the cyclic shift sequence, and the orthogonal cover sequence are based on first, second, and third functions gₐ, g_{b}, and g_{c}, respectively. Also for example, the UE 802 may use a system time as the random variable.

More particularly, the first, second, and third functions gₐ, g_{b}, and g_{c} may be considered as permutation functions. For example, at a system time tᵢ, an index mₜ_{ᵢ} for the RB, an index CSₜ_{ᵢ} for the cyclic shift sequence, and an index OCₜ_{ᵢ} for the orthogonal cover sequence may be calculated as follows:

mₜ_{ᵢ}=gₐ(mₜ_{₀},tᵢ)=(mₜ_{₀}+tᵢ)mod(Kₘ),

CSₜ_{ᵢ}=g_{b}(CSₜ_{₀},tᵢ)=(CSₜ_{₀}+tᵢ)mod(K_{CS}),

OCₜ_{ᵢ}=g_{c}(OCₜ_{₀},tᵢ)=(OCₜ_{₀}+tᵢ)mod(K_{OC}), equations (1b)

where Kₘ is a total number of the RBs having an even-number index for the ACK/NACK transmission, if mₜ_{₀} is an even number, or is a total number of the RBs having an odd-number index for the ACK/NACK transmission, if mₜ_{₀} is an odd number; K_{CS} is a number of subcarriers for each of the RBs, e.g., K_{CS}=12; and K_{OC} is a predetermined parameter, e.g., K_{OC}=2 or 3 depending on configuration of normal or extended cyclic prefix (CP) in an OFDM symbol. The CP in an OFDM symbol is known in the art and, hence, will not be discussed further. In addition, UE-specific parameters, e.g., a UE ID, may also be used to calculate mₜ_{ᵢ}, CSₜ_{ᵢ}, and OCₜ_{ᵢ}, based on the first, second, and third functions gₐ, g_{b}, and g_{c}, respectively.

In exemplary embodiments, the UE 802 may determine the RB, the cyclic shift sequence, and the orthogonal cover sequence periodically or aperiodically. For example, FIG. 8 shows determination of the RB, the cyclic shift sequence, and the orthogonal cover sequence at first and second system times t₁ and t₂. In FIG. 8, mₜ_{₁}, CSₜ_{₁}, and OCₜ_{₁} are indexes for the determined RB, the determined cyclic shift sequence, and the determined orthogonal cover sequence, respectively, at the first system time t₁, and mₜ_{₂}, CSₜ_{₂}, and OCₜ_{₂} are indexes for the determined RB, the determined cyclic shift sequence, and the determined orthogonal cover sequence, respectively, at the second system time t₂.

In exemplary embodiments, the UE 802 further transmits uplink control information based on the determined RB, the determined cyclic shift sequence, and the determined orthogonal cover sequence, e.g., using the method 500 (FIG. 5). Because the RB, the cyclic shift sequence, and the orthogonal cover sequence are randomly determined, multiple-access interference may be reduced between different UEs.

In exemplary embodiments, one or more rules may be set up for the UE 802 to randomly determine the RB. For example, if the index mₒ for the initial RB is an even number, the index for the determined RB should also be an even number. If the index mₒ for the initial RB is an odd number, the index for the determined RB should also be an odd number. The RB determined in such manner is for frequency diversity for uplink control signals.

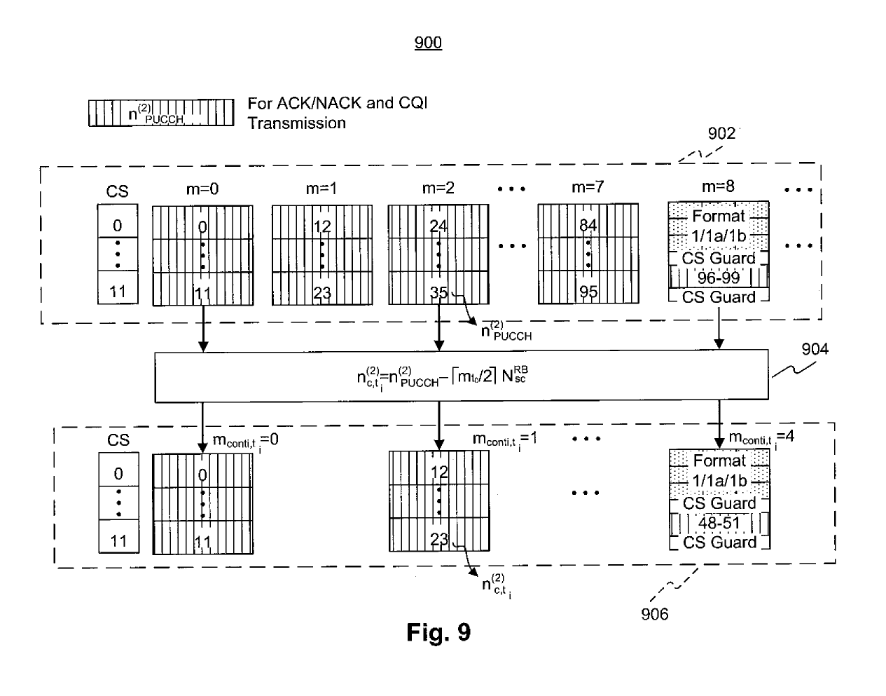

FIGS. 9-12 illustrate methods 900-1200, respectively, for a UE to randomly determine an RB and a cyclic shift sequence for performing the ACK/NACK and CQI transmission, according to exemplary embodiments. For example, the UE is a first one of the UEs in the above-described communication system. In the illustrated embodiments, it is assumed that each of the RBs for the PUCCH includes N_{SC}^{RB} subcarriers. It is also assumed that N_{RB}⁽¹⁾ of the RBs for the PUCCH are used only for the ACK/NACK transmission and N_{RB}⁽²⁾ of the RBs for the PUCCH are used only for the ACK/NACK and CQI transmission. It is further assumed that one of the RBs for the PUCCH, referred to herein as a mixed-format RB, is used for both the ACK/NACK and CQI transmission and the ACK/NACK transmission, and n_{CS}⁽¹⁾ of the plurality of cyclic shift sequences are reserved for the ACK/NACK transmission in the mixed-format RB.

In one exemplary embodiment, shown in FIG. 9, a lookup table 902 is configured by the base station and provided by the base station to the UE. The lookup table 902 maps each of a plurality of resource indexes to one of the RBs allocated for the PUCCH and one of the plurality of cyclic shift sequences. For example, the resource indexes 0-99 are used for the ACK/NACK and CQI transmission.

The base station also assigns to the UE a resource index n_{PUCCH}⁽²⁾ in the lookup table 902. Based on the lookup table 902, the UE maps the assigned resource index n_{PUCCH}⁽²⁾ to an initial RB with an index mₜ_{₀}. In the illustrated embodiment, the index mₜ_{₀} for the initial RB is an even number. Therefore the UE further determines a total number Y_{(A)} of the resource indexes for the ACK/NACK and CQI transmission that correspond to the RBs having an even-number index, i.e., the RBs with m=0, 2, . . . , and 8. For example, if it is further determined that (N_{RB}⁽²⁾┌N_{CS}⁽¹⁾/N_{SC}^{RB}┐−1)mod 2=0, the UE calculates Y_{(A)} as follows:

Y_{α}=┌N_{RB}⁽²⁾/2┐N_{SC}^{RB},

Y_{β}=(N_{SC}^{RB}−2−N_{CS}⁽¹⁾),

Y_{(A)}=Y_{α}+Y_{β}, equations (2)

where Y_{α} and Y_{β} are temporary variables, and “┌ ┐” denotes a ceiling operation.

The UE also revises the assigned resource index n_{PUCCH}⁽²⁾ to generate a revised resource index n_{c,t}_{ᵢ} (904). For different values of the assigned resource index n_{PUCCH}⁽²⁾ that correspond to the RBs having an even-number index, i.e., the RBs with m=0, 2, . . . , and 8, corresponding values of the revised resource index n_{c,t}_{ᵢ}⁽²⁾, are shown in a table 906. For example, the revised resource index n_{c,t}_{ᵢ}⁽²⁾ may be generated as follows:

n_{c,t}_{ᵢ}⁽²⁾=n_{PUCCH}⁽²⁾−┌mₜ_{₀}/2┐N_{SC}^{RB}, equation (3)

where “┌ ┐” denotes a ceiling operation.

The UE then calculates a virtual resource index n_{PUCCH,t}_{ᵢ}⁽²⁾ at a system time tᵢ, and uses the virtual resource index n_{PUCCH,t}_{ᵢ}⁽²⁾ to further determine an RB from the RBs allocated for the PUCCH and a cyclic shift sequence from the plurality of cyclic shift sequences, as follows:

n_{PUCCH,t}_{ᵢ}⁽²⁾=(n_{c,t}_{ᵢ}⁽²⁾+tᵢ)mod Y_{(A)},

CSₜ_{ᵢ}=ν′(n_{PUCCH,t}_{ᵢ}⁽²⁾,Y_{α}, . . . ),

m_{conti,t}_{ᵢ}=└n_{PUCCH,t}_{ᵢ}⁽²⁾/N_{SC}^{RB}┘,

mₜ_{ᵢ}=2m_{conti,t}_{ᵢ}, equations (4)

where CSₜ_{ᵢ} is the index for the determined cyclic shift sequence at the system time tᵢ, mₜ_{ᵢ} is the index for the determined RB at the system time tᵢ, “└ ┘” denotes a floor operation, ν′ is a function to calculate CSₜ_{ᵢ}, and m_{conti,t}_{ᵢ} is a temporary variable. As a result, the UE performs the ACK/NACK and CQI transmission based on the determined cyclic shift sequence with the index CSₜ_{ᵢ} and the determined RB with the index mₜ_{ᵢ}.

For example, if N_{CS}⁽¹⁾=6, N_{RB}⁽²⁾=8, n_{PUCCH}⁽²⁾=25, and tᵢ=200, the UE determines the RB and the cyclic shift sequence, as follows:

$${n}_{c , {t}_{i}}^{( 2 )} = {n}_{PUCCH}^{( 2 )} - ⌈ {m}_{{t}_{0}} / 2 ⌉ {N}_{sc}^{RB} = 25 - 12 = 13 , \\ {n}_{PUCCH , {t}_{i}}^{( 2 )} = ( {n}_{c , {t}_{i}}^{( 2 )} + {t}_{i} ) mod {Y}_{( A )} = 213 mod 52 = 5 , \\ {CS}_{{t}_{i}} = \{ \begin{matrix}{n}_{PUCCH , {t}_{i}}^{( 2 )} mod {N}_{sc}^{RB} , & if {n}_{PUCCH , {t}_{i}}^{( 2 )} < {Y}_{a} \\ {n}_{PUCCH , {t}_{i}}^{( 2 )} + {N}_{cs}^{( 1 )} + 1 , & otherwise\end{matrix} \to {CS}_{{t}_{i}} = 5 , \\ {m}_{conti , {t}_{i}} = ⌊ {n}_{PUCCH , {t}_{i}}^{( 2 )} / {N}_{sc}^{RB} ⌋ = 0 , \\ {m}_{{t}_{i}} = 2 {m}_{conti , {t}_{i}} = 0. \qquad equations ( 5 )$$

As a result, the UE performs the ACK/NACK and CQI transmission based on the determined cyclic shift sequence with the index CSₜ_{ᵢ}=5 and the determined RB with the index mₜ_{ᵢ}=0, at the system time tᵢ=200.

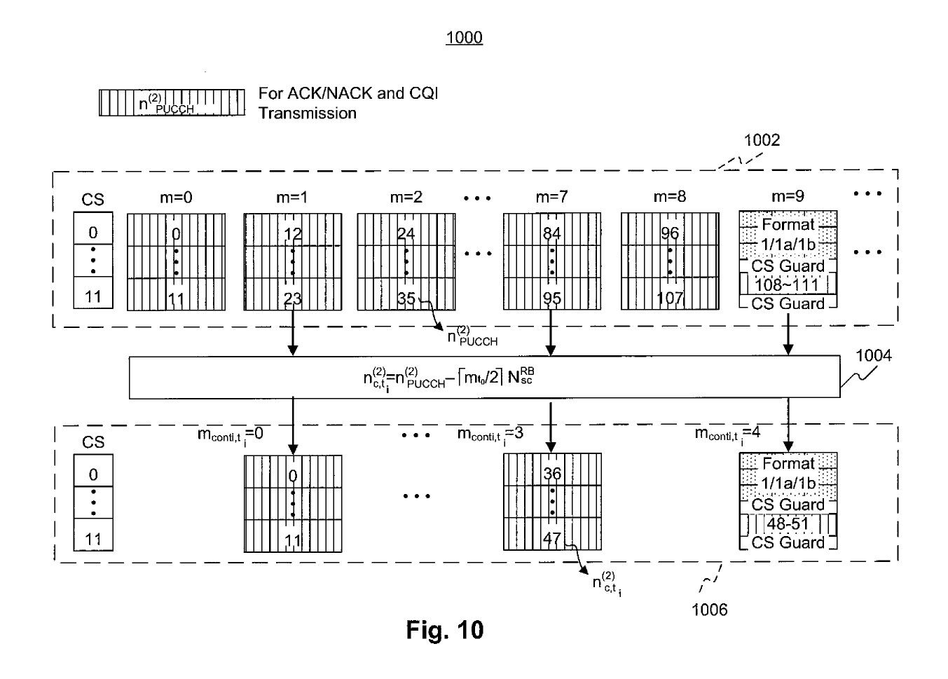

In one exemplary embodiment, shown in FIG. 10, a lookup table 1002 is configured by the base station and provided by the base station to the UE. The lookup table 1002 maps each of a plurality of resource indexes to one of the RBs allocated for the PUCCH and one of the plurality of cyclic shift sequences. For example, the resource indexes 0-111 are used for the ACK/NACK and CQI transmission.

The base station assigns to the UE a resource index n_{PUCCH}⁽²⁾ in the lookup table 1002. Based on the lookup table 1002, the UE maps the assigned resource index n_{PUCCH}⁽²⁾ to an initial RB with an index mₜ_{ₒ}. In the illustrated embodiment, the index mₜ_{ₒ} for the initial RB is an odd number. Therefore the UE further determines a total number Y_{(B)} of the resource indexes for the ACK/NACK and CQI transmission that correspond to the RBs having an odd-number index, i.e., the RBs with m=1, 3, . . . , and 9. For example, if it is further determined that (N_{RB}⁽²⁾+┌N_{CS}⁽¹⁾/N_{SC}^{RB}┐−1)mod 2=1, the UE calculates Y_{(B)} as follows:

Y_{α}=└N_{RB}⁽²⁾/2┘N_{SC}^{RB},

Y_{β}=(N_{SC}^{RB}−2−N_{CS}⁽¹⁾,

Y_{(B)}=Y_{α}+Y_{β}, equations (6)

where Y_{α} and Y_{β} are temporary variables.

The UE also revises the assigned resource index n_{PUCCH}⁽²⁾ to generate a revised resource index n_{c,t}_{ᵢ}⁽²⁾. For different values of the assigned resource index n_{PUCCH}⁽²⁾ that correspond to the RBs having an odd-number index, i.e., the RBs with m=1, 3, . . . , 9, corresponding values of the revised resource index n_{,t}_{ᵢ}⁽²⁾ are shown in a table 1006. For example, the revised resource index n_{c,t}_{ᵢ}⁽²⁾ may be generated as follows:

n_{c,t}_{ᵢ}⁽²⁾=n_{PUCCH}⁽²⁾−┌mₜ_{₀}/2┐N_{SC}^{RB}, equation (7)

where “┌ ┐” denotes a ceiling operation.

The UE then calculates a virtual resource index n_{PUCCH,t}_{ᵢ}⁽²⁾, at a system time tᵢ, and uses the virtual resource index n_{PUCCH,t}_{ᵢ}⁽²⁾ to further determine an RB from the RBs allocated for the PUCCH and a cyclic shift sequence from the plurality of cyclic shift sequences, as follows:

n_{PUCCH,t}_{ᵢ}⁽²⁾=(n_{c,t}_{ᵢ}⁽²⁾+tᵢ)mod Y_{(B)},

CSₜ_{ᵢ}=ν′(n_{PUCCH,t}_{ᵢ}⁽²⁾,Y_{α}, . . . ),

m_{conti,t}_{ᵢ}=└n_{PUCCH,t}_{ᵢ}⁽²⁾/N_{SC}^{RB}┘,

mₜ_{ᵢ}=2m_{conti,t}_{ᵢ}+1, equations (8)

where CSₜ_{ᵢ} is the index for the determined cyclic shift sequence at the system time tᵢ, mₜ_{ᵢ} is the index for the determined RB at the system time tᵢ, “└ ┘” denotes a floor operation, ν′ is a function to calculate CSₜ_{ᵢ}, and m_{conti,t}_{ᵢ} is a temporary variable. As a result, the UE performs the ACK/NACK and CQI transmission based on the determined cyclic shift sequence with the index CSₜ_{ᵢ} and the determined RB with the index mₜ_{ᵢ}.

For example, if N_{CS}⁽¹⁾=6, N_{RB}⁽²⁾=9, n_{PUCCH}⁽²⁾=13, and tᵢ=200, the UE determines the RB and the cyclic shift sequence, as follows:

$${n}_{c , {t}_{i}}^{( 2 )} = {n}_{PUCCH}^{( 2 )} - ⌈ {m}_{{t}_{0}} / 2 ⌉ {N}_{sc}^{RB} = 13 - 12 = 1 , \\ {n}_{PUCCH , {t}_{i}}^{( 2 )} = ( {n}_{c , {t}_{i}}^{( 2 )} + {t}_{i} ) mod {Y}_{( B )} = 201 mod 52 = 45 , \\ {CS}_{{t}_{i}} = \{ \begin{matrix}{n}_{PUCCH , {t}_{i}}^{( 2 )} mod {N}_{sc}^{RB} , & if {n}_{PUCCH , {t}_{i}}^{( 2 )} < {Y}_{a} \\ {n}_{PUCCH , {t}_{i}}^{( 2 )} + {N}_{cs}^{( 1 )} + 1 , & otherwise\end{matrix} \to {CS}_{{t}_{i}} = 9 , \\ {m}_{conti , {t}_{i}} = ⌊ {n}_{PUCCH , {t}_{i}}^{( 2 )} / {N}_{sc}^{RB} ⌋ = 3 , \\ {m}_{{t}_{i}} = 2 {m}_{conti , {t}_{i}} + 1 = 7. \qquad equations ( 9 )$$

As a result, the UE performs the ACK/NACK and CQI transmission based on the determined cyclic shift sequence with the index CSₜ_{ᵢ}=9 and the determined RB with the index mₜ_{ᵢ}=7, at the system time tᵢ=200.

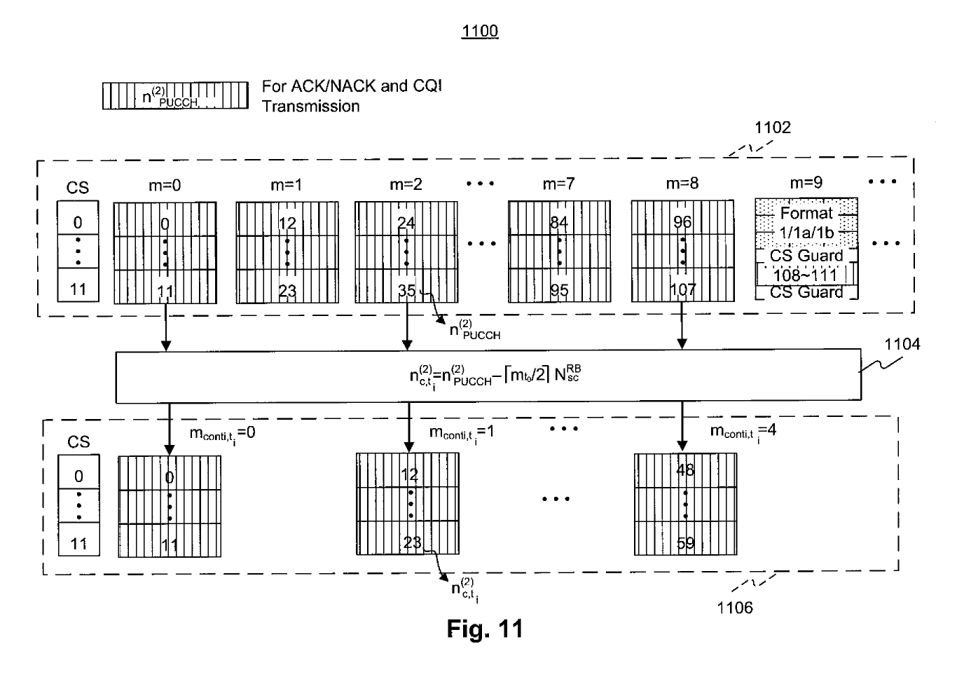

In one exemplary embodiment, shown in FIG. 11, a lookup table 1102 is configured by the base station and provided by the base station to the UE. The lookup table 1102 maps each of a plurality of resource indexes to one of the RBs allocated for the PUCCH and one of the plurality of cyclic shift sequences. For example, the resource indexes 0-111 are used for the ACK/NACK and CQI transmission.

The base station assigns to the UE a resource index n_{PUCCH}⁽²⁾ in the lookup table 1102. Based on the lookup table 1102, the UE maps the assigned resource index n_{PUCCH}⁽²⁾ to an initial RB with an index mₜ_{ᵢ}. In the illustrated embodiment, the index mₜ_{ᵢ} for the initial RB is an even number. Therefore the UE further determines a total number Y_{(C)} of the resource indexes for the ACK/NACK and CQI transmission that correspond to the RBs having an even-number index, i.e., the RBs with m=0, 2, . . . , and 8. For example, if it is further determined that (N_{RB}⁽²⁾+┌N_{CS}⁽¹⁾/N_{SC}^{RB}┐−1)mod 2=1, the UE calculates Y_{(C)} as follows:

Y_{α┌N}_{RB}⁽²⁾/2┐N_{SC}^{RB},

Y_{β}=0,

Y_{(C)}=Y_{α}+Y_{β}, equations (10)

where Y_{α} and Y_{β} are temporary variables.

The UE also revises the assigned resource index n_{PUCCH}⁽²⁾ to generate a revised resource index n_{c,t}_{ᵢ}⁽²⁾. For different values of the assigned resource index n_{PUCCH}⁽²⁾ that correspond to the RBs having an even-number index, i.e., the RBs with m=0, 2, . . . , and 8, corresponding values of the revised resource index n_{c,t}_{ᵢ} are shown in a table 1106. For example, the revised resource index n_{c,t}_{ᵢ}⁽²⁾ may be generated as follows:

n_{c,t}_{ᵢ}⁽²⁾=n_{PUCCH}⁽²⁾−┌mₜ_{₀}/2┐N_{SC}^{RB}, equation (11)

where “┌ ┐” denotes a ceiling operation.

The UE then calculates a virtual resource index n_{PUCCH,t}_{ᵢ}⁽²⁾ at a system time tᵢ, and uses the virtual resource index n_{PUCCH,t}_{ᵢ}⁽²⁾ to further determine an RB from the RBs allocated for the PUCCH and a cyclic shift sequence from the plurality of cyclic shift sequences, as follows:

n_{PUCCH,t}_{ᵢ}⁽²⁾=(n_{c,t}_{ᵢ}⁽²⁾+tᵢ)mod Y_{(C)},

CSₜ_{ᵢ}=ν′(n_{PUCCH,t}_{ᵢ}⁽²⁾,Y_{α}, . . . ),

m_{conti,t}_{ᵢ}=└n_{PUCCH,t}_{ᵢ}⁽²⁾N_{SC}^{RB}┘,

mₜ_{ᵢ}=2m_{coni,t}_{ᵢ}, equations (12)

where CSₜ_{ᵢ} is the index for the determined cyclic shift sequence at the system time tᵢ, mₜ_{ᵢ} is the index for the determined RB at the system time tᵢ, “└ ┘” denotes a floor operation, ν′ is a function to calculate CSₜ_{ᵢ}, and m_{conti,t}_{ᵢ} is a temporary variable. As a result, the UE performs the ACK/NACK and CQI transmission based on the determined cyclic shift sequence with the index CSₜ_{ᵢ} and the determined RB with the index mₜ_{ᵢ}.

For example, if N_{CS}⁽¹⁾=6, N_{RB}⁽²⁾=9, n_{PUCCH}⁽²⁾=25, and tᵢ=200, the UE determines the RB and the cyclic shift sequence, as follows:

n_{c,t}_{ᵢ}=n_{PUCCH}⁽²⁾−┌mₜ_{₀}/2┐N_{SC}^{RB}=25−1·12=13,

n_{PUCCH,t}_{ᵢ}⁽²⁾=(n_{c,t}_{ᵢ}⁽²⁾+tᵢ)mod Y_{(C)}=213 mod 60=33,

CSₜ_{ᵢ}=n_{PUCCH,t}_{ᵢ}⁽²⁾mod N_{sc}^{RB}→CSₜ_{ᵢ}=9,

m_{cont i,t}_{ᵢ}=└n_{PUCCH,t}_{ᵢ}⁽²⁾N_{SC}^{RB}┘=└33/12┘=2,

mₜ_{ᵢ}=2m_{conti,t}_{ᵢ}=4. equations (13)

As a result, the UE performs the ACK/NACK and CQI transmission based on the determined cyclic shift sequence with the index CSₜ_{ᵢ}=9 and the determined RB with the index mₜ_{ᵢ}=4, at the system time tᵢ=200.

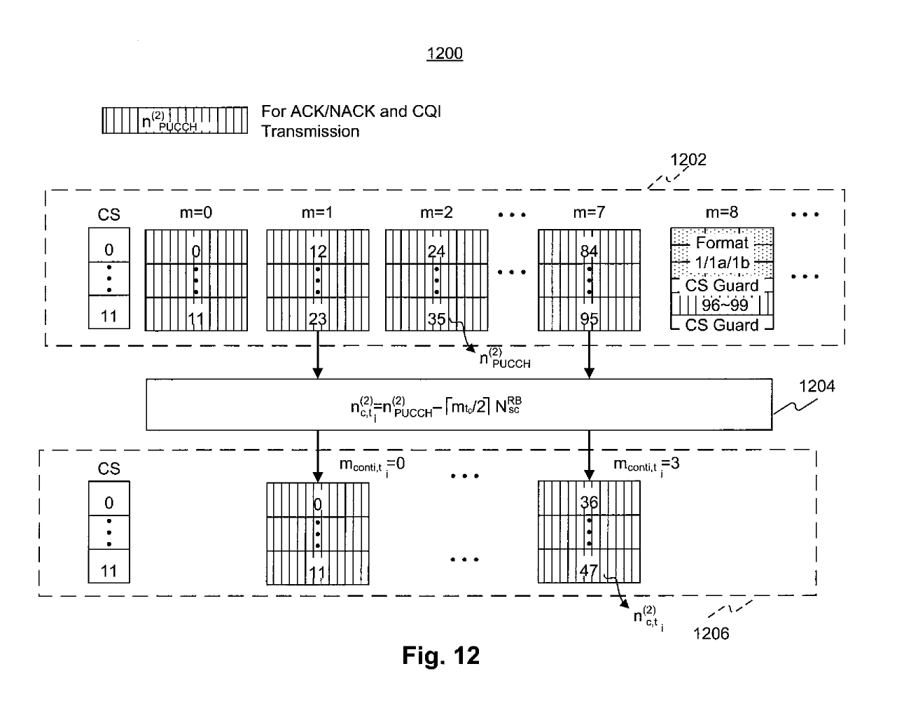

In one exemplary embodiment, shown in FIG. 12, a lookup table 1202 is configured by the base station and provided by the base station to the UE. The lookup table 1202 maps each of a plurality of resource indexes to one of the RBs allocated for the PUCCH and one of the plurality of cyclic shift sequences. For example, the resource indexes 0-99 are used for the ACK/NACK and CQI transmission.

The base station assigns to the UE a resource index n_{PUCCH}⁽²⁾ in the lookup table 1202. Based on the lookup table 1202, the UE maps the assigned resource index n_{PUCCH}⁽²⁾ to an initial RB with an index mₜ_{₀}. In the illustrated embodiment, the index mₜ_{₀} for the initial RB is an odd number. Therefore the UE further determines a total number Y_{(D)} of the resource indexes for the ACK/NACK and CQI transmission that correspond to the RBs having an odd-number index, i.e., the RBs with m=1, 3, . . . , and 7. For example, if it is further determined that (N_{RB}⁽²⁾+┌N_{CS}⁽¹⁾/N_{SC}^{RB}┐−1)mod 2=0, the UE calculates Y_{(D)} as follows:

Y_{α}=└N_{RB}⁽²⁾/2┘N_{SC}^{RB},

Y_{β}=0,

Y_{(D)}=Y_{α}+Y_{β}, equations (14)

where Y_{α} and Y_{β} are temporary variables.

The UE also revises the assigned resource index n_{PUCCH}⁽²⁾ to generate a revised resource index n_{c,t}_{ᵢ}⁽²⁾. For different values of the assigned resource index n_{PUCCH}⁽²⁾ that correspond to the RBs having an odd-number index, i.e., the RBs with m=1, 3, . . . , and 7, corresponding values of the revised resource index n_{c,t}_{ᵢ}⁽²⁾ are shown in a table 1206. For example, the revised resource index n_{c,t}_{ᵢ}⁽²⁾ may be generated as follows:

n_{c,t}_{ᵢ}⁽²⁾=n_{PUCCH}⁽²⁾−┌mₜ_{₀}/2┐N_{SC}^{RB}, equation (15)

where “┌ ┐” denotes a ceiling operation.

The UE then calculates a virtual resource index n_{PUCCH,t}_{ᵢ}⁽²⁾ at a system time tᵢ, and uses the virtual resource index n_{PUCCH,t}_{ᵢ}⁽²⁾ to further determine an RB from the RBs allocated for the PUCCH and a cyclic shift sequence from the plurality of cyclic shift sequences, as follows:

n_{PUCCH,t}_{ᵢ}⁽²⁾=(n_{c,t}_{ᵢ}⁽²⁾+tᵢ)mod Y_{(D)},

CSₜ_{ᵢ}=ν′(n_{PUCCH,t}_{ᵢ}⁽²⁾,Y_{α}, . . . ),

m_{cont i,t}_{ᵢ}=└n_{PUCCH,t}_{ᵢ}⁽²⁾/N_{SC}^{RB}┘,

mₜ_{ᵢ}=2m_{conti,t}_{ᵢ}+1, equations (16)

where CSₜ_{ᵢ} is the index for the determined cyclic shift sequence at the system time tᵢ, mₜ_{ᵢ} is the index for the determined RB at the system time tᵢ, “└ ┘” denotes a floor operation, ν′ is a function to calculate CSₜ_{ᵢ}, and m_{conti,t}_{ᵢ} is a temporary variable. As a result, the UE performs the ACK/NACK and CQI transmission based on the determined cyclic shift sequence with the index CSₜ_{ᵢ} and the determined RB with the index mₜ_{_{i.}}

For example, if N_{CS}⁽¹⁾=6, N_{RB}⁽²⁾=8, n_{PUCCH}⁽²⁾=16, and tᵢ=200, the UE determines the RB and the cyclic shift sequence, as follows:

n_{c,t}_{ᵢ}⁽²⁾=n_{PUCCH}⁽²⁾−┌mₜ_{₀}/2┐N_{SC}^{RB}=16−12=4,

n_{PUCCH,t}_{ᵢ}⁽²⁾=(n_{c,t}_{ᵢ}⁽²⁾+tᵢ)mod Y_{(D)}=204 mod 48=12,

CSₜ_{ᵢ}=n_{PUCCH,t}_{ᵢ}⁽²⁾mod N_{SC}^{RB}=0,

m_{cont i,t}_{ᵢ}=└n_{PUCCH,t}_{ᵢ}⁽²⁾/N_{SC}^{RB}┘=1,

mₜ_{ᵢ}=2m_{conti,t}_{ᵢ}+1=3. equations (17)

As a result, the UE performs the ACK/NACK and CQI transmission based on the determined cyclic shift sequence with the index CSₜ_{ᵢ}=0 and the determined RB with the index mₜ_{ᵢ}=3, at the system time tᵢ=200.

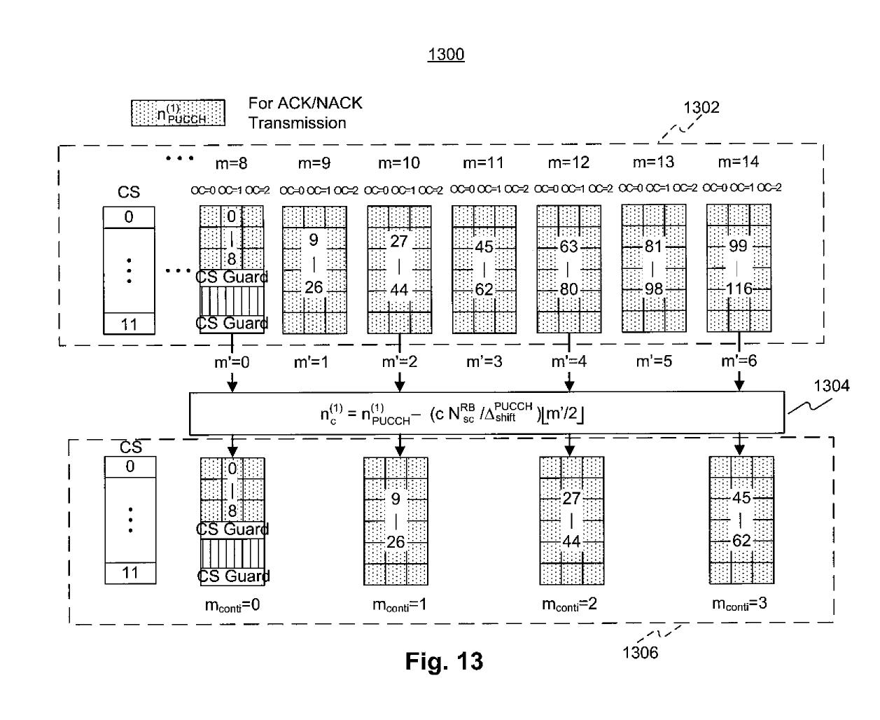

FIGS. 13-16 illustrate methods 1300-1600, respectively, for a UE to randomly determine an RB, a cyclic shift sequence, and an orthogonal cover sequence for performing the ACK/NACK transmission, according to exemplary embodiments. For example, the UE is a first one of the UEs in the above-described communication system. In the illustrated embodiments, it is assumed that each of the RBs for the PUCCH includes N_{SC}^{RB} subcarriers. It is also assumed that N_{RB}⁽¹⁾ of the RBs for the PUCCH are used only for the ACK/NACK transmission and N_{RB}⁽²⁾ of the RBs for the PUCCH are used only for the ACK/NACK and CQI transmission. It is further assumed that one of the RBs for the PUCCH, referred to herein as a mixed-format RB, is used for both the ACK/NACK and CQI transmission and the ACK/NACK transmission, and N_{CS}⁽¹⁾ of the plurality of cyclic shift sequences are reserved for the ACK/NACK transmission in the mixed-format RB.

In one exemplary embodiment, in accordance with the method 1300 shown in FIG. 13, a lookup table 1302 is configured by the base station and provided by the base station to the UE. The lookup table 1302 maps each of a plurality of resource indexes to one of the RBs allocated for the PUCCH, one of the plurality of cyclic shift sequences, and one of the plurality of orthogonal cover sequences. For example, the resource indexes 0-116 are used for the ACK/NACK transmission.

The base station assigns to the UE a resource index n_{PUCCH}⁽¹⁾ in the lookup table 1302. Based on the lookup table 1302, the UE maps the assigned resource index n_{PUCCH}⁽¹⁾ to an initial RB with an index mₜ_{ₒ}. In the exemplary embodiment, the index mₜ_{₀} for the initial RB is an even number, and the index for the mixed-format RB is also an even number.

The UE also revises the assigned resource index n_{PUCCH}⁽¹⁾ to generate a revised resource index n_{c}⁽¹⁾ (1304). For different values of the assigned resource index n_{PUCCH}⁽¹⁾ that correspond to the RBs having an even-number index, i.e., the RBs with m=8, 10, . . . , and 14, corresponding values of the revised resource index n_{c}⁽¹⁾ are shown in a table 1306. For example, the revised resource index n_{c}⁽¹⁾ may be generated as follows:

m′=mₜ_{₀}−N_{RB}⁽²⁾,

n_{c}⁽¹⁾=n_{PUCCH}⁽¹⁾−(cN_{SC}^{RB}/Δ_{shift}^{PUCCH})└m′/2┘−(cN_{CS}⁽¹⁾/Δ_{shift}^{PUCCH}−Y_{δ}), equations (18)

where Δ_{shift}^{PUCCH} denotes a minimal cyclic shift spacing for n_{PUCCH}⁽¹⁾ for a given orthogonal cover sequence, as illustrated in FIG. 6, c is a number of indexes for the plurality of orthogonal cover sequences and is determined based on, e.g., a length of CP in an OFDM symbol; and Y_{δ}=cN_{CS}⁽¹⁾/Δ_{shift}^{PUCCH} is a number of resource indexes for the ACK/NACK transmission in the mixed-format RB if mₜ_{ₒ} and the index of the mixed-format RB are both even or both odd, otherwise Y_{δ}=0.

The UE then calculates a virtual resource index n_{PUCCH,t}_{ᵢ}⁽¹⁾ at a system time tᵢ, and uses the virtual resource index n_{PUCCH,t}_{ᵢ}⁽¹⁾ to further determine an RB from the RBs allocated for the PUCCH, a cyclic shift sequence from the plurality of cyclic shift sequences, and an orthogonal cover sequence from the plurality of orthogonal cover sequences, as follows:

n_{PUCCH,t}_{ᵢ}⁽¹⁾=(n_{c}⁽¹⁾+tᵢ)mod Y_{(E)},

OCₜ_{ᵢ}θ(n_{PUCCH,t}_{ᵢ}⁽¹⁾,N_{CS}⁽¹⁾,Δ_{shift}^{PUCCH},c, . . . ),

CSₜ_{ᵢ}=ν(n_{PUCCH,t}_{ᵢ}⁽¹⁾,N_{CS}⁽¹⁾,Δ_{shift}^{PUCCH},c,OCₜ_{ᵢ}, . . . ),

mₜ_{ᵢ}=ρ(n_{PUCCH,t}_{ᵢ}⁽¹⁾,N_{CS}⁽¹⁾,Δ_{shift}^{PUCCH},c,N_{RB}⁽²⁾), equations (19)

where mₜ_{ᵢ}, CSₜ_{ᵢ}, and OCₜ_{ᵢ} are the indexes for the determined RB, the determined cyclic shift sequence, and the determined orthogonal cover sequence, respectively, at the system time tᵢ; Y_{(E)} is a total number of the resource indexes for the ACK/NACK transmission that correspond to the RBs having an even-number index; and θ, ν, and ρ are predetermined functions.

In one exemplary embodiment, mₜ_{ᵢ}, CSₜ_{ᵢ}, and OCₜ_{ᵢ} are calculated as follows:

$$\begin{matrix}{n}^{′} = \{ \begin{matrix}{n}_{PUCCH , {t}_{i}}^{( 1 )} , & if {n}_{PUCCH , {t}_{i}}^{( 1 )} < \frac{{cN}_{cs}^{( 1 )}}{{Δ}_{shift}^{PUCCH}} \\ ( {n}_{PUCCH , {t}_{i}}^{( 1 )} , - \frac{{cN}_{cs}^{( 1 )}}{{Δ}_{shift}^{PUCCH}} ) mod ( \frac{{cN}_{SC}^{RB}}{{Δ}_{shift}^{PUCCH}} ) , & otherwise ,\end{matrix} & equations ( 20 ) \\ {OC}_{{t}_{i}} = \{ \begin{matrix}⌊ \frac{{n}^{′} {Δ}_{shift}^{PUCCH}}{{N}^{′}} ⌋ , & for normal CP \\ 2 ⌊ \frac{{n}^{′} {Δ}_{shift}^{PUCCH}}{{N}^{′}} ⌋ , & for extended CP ,\end{matrix} & \\ {CS}_{{t}_{i}} = \{ \begin{matrix}[ \begin{matrix}{n}_{cs}^{cell} ( {n}_{s} , l ) + \\ ( \begin{matrix}{n}^{′} {Δ}_{shift}^{PUCCH} + \\ ( {OC}_{{t}_{i}} mod {Δ}_{shift}^{PUCCH} )\end{matrix} ) mod {N}^{′}\end{matrix} ] mod {N}_{SC}^{RB} , & for normal CP \\ [ \begin{matrix}{n}_{cs}^{cell} ( {n}_{s} , l ) + \\ ( \begin{matrix}{n}^{′} {Δ}_{shift}^{PUCCH} + \\ \frac{{OC}_{t}}{2}\end{matrix} ) mod {N}^{′}\end{matrix} ] mod {N}_{SC}^{RB} , & for extended CP ,\end{matrix} & \\ {m}_{conti , {t}_{i}} \{ \begin{matrix}0 , & if {n}_{PUCCH , {t}_{i}}^{( 1 )} < \frac{{cN}_{CS}^{( 1 )}}{{Δ}_{shift}^{PUCCH}} \\ ⌊ \frac{{n}_{PUCCH , {t}_{i}}^{( 1 )} - \frac{{cN}_{CS}^{( 1 )}}{{Δ}_{shift}^{PUCCH}}}{\frac{{cN}_{SC}^{RB}}{{Δ}_{shift}^{PUCCH}}} ⌋ + ⌈ \frac{{N}_{CS}^{( 1 )}}{8} ⌉ , & otherwise ,\end{matrix} & \\ {m}_{{t}_{i}} = 2 {m}_{conti , {t}_{i}} + {N}_{RB}^{( 2 )} \\ where & \\ {N}^{′} = \{ \begin{matrix}{N}_{cs}^{( 1 )} , & if {n}_{PUCCH , {t}_{i}}^{( 1 )} < \frac{{cN}_{cs}^{( 1 )}}{{Δ}_{shift}^{PUCCH}} \\ {N}_{SC}^{RB} , & otherwise ;\end{matrix} & \end{matrix}$$

c=3 for normal CP and c=2 for extended CP; and
n_{cs}^{cell}(nₛ,l) is a cell-specific parameter for slot nₛ and symbol l, and is assumed to be zero.

Alternatively, the UE may directly determine the RB, the cyclic shift sequence, and the orthogonal cover sequence by looking up in the table 1306 the virtual resource index n_{PUCCH,t}_{ᵢ} calculated in equations (19).

For example, if N_{CS}⁽¹⁾=6, N_{RB}⁽²⁾=8, N_{RB}⁽¹⁾=6, c=3, Δ_{shift}^{PUCCH}=2, n_{PUCCH}⁽¹⁾=5, and tᵢ=200, the UE calculates the virtual resource index n_{PUCCH,t}_{ᵢ}⁽¹⁾ as follows:

m′=mₜ_{₀}−N_{RB}⁽²⁾=0,

n_{c}⁽¹⁾=n_{PUCCH}⁽¹⁾−(cN_{SC}^{RB}/Δ_{shift}^{PUCCH})└m′/2┘=5,

n_{PUCCH,t}_{ᵢ}⁽¹⁾=(n_{c}⁽¹⁾+tᵢ)mod Y_{(E)}=205 mod 63=16. equations (21)

The UE further determines the RB, the cyclic shift sequence, and the orthogonal cover sequence based on the virtual resource index n_{PUCCH,t}_{ᵢ}⁽¹⁾=16, and the calculations according to equations (20) or the table 1306. The UE then performs the ACK/NACK transmission based on the determined RB, the determined cyclic shift sequence, and the determined orthogonal cover sequence, e.g., using the method 500 (FIG. 5).

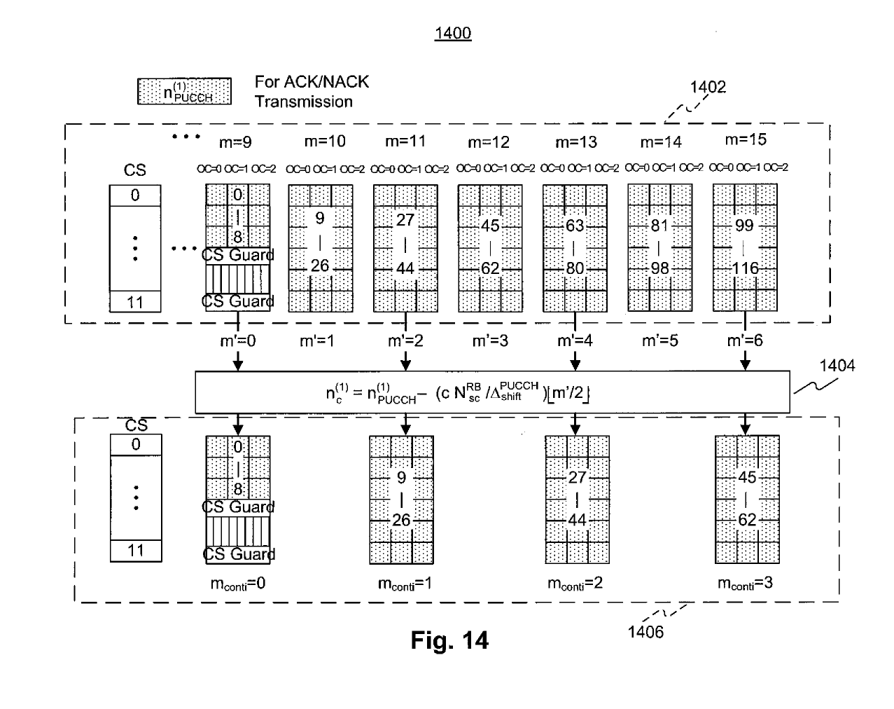

In one exemplary embodiment, in accordance with the method 1400 shown in FIG. 14, a lookup table 1402 is configured by the base station and provided by the base station to the UE. The lookup table 1402 maps each of a plurality of resource indexes to one of the RBs allocated for the PUCCH, one of the plurality of cyclic shift sequences, and one of the plurality of orthogonal cover sequences. For example, the resource indexes 0-116 are used for the ACK/NACK transmission.

The base station assigns to the UE a resource index n_{PUCCH}⁽¹⁾ in the lookup table 1402. Based on the lookup table 1402, the UE maps the assigned resource index n_{PUCCH}⁽¹⁾ to an initial RB with an index mₜ_{₀}. In the exemplary embodiment, the index mₜ_{₀} for the initial RB is an odd number, and the index for the mixed-format RB is also an odd number.

The UE also revises the assigned resource index n_{PUCCH}⁽¹⁾ to generate a revised resource index n_{c}⁽¹⁾ (1404). For different values of the assigned resource index n_{PUCCH}⁽¹⁾ that correspond to the RBs having an odd-number index, i.e., the RBs with m=9, 11, . . . , and 15, corresponding values of the revised resource index n_{c}⁽¹⁾ are shown in a table 1406. For example, the revised resource index n_{c}⁽¹⁾ may be generated according to equations (18).

Similar to the above description provided for the method 1300, the UE then calculates a virtual resource index n_{PUCCH,t}_{ᵢ}⁽¹⁾ at a system time tᵢ, and uses the virtual resource index n_{PUCCH,t}_{ᵢ}⁽¹⁾ to further determine an RB from the RBs allocated for the PUCCH, a cyclic shift sequence from the plurality of cyclic shift sequences, and an orthogonal cover sequence from the plurality of orthogonal cover sequences based on the predetermined functions θ, ν, and ρ. Alternatively, the UE may directly determine the RB, the cyclic shift sequence, and the orthogonal cover sequence by looking up in the table 1406 the virtual resource index n_{PUCCH,t}_{ᵢ}⁽¹⁾.

For example, if N_{CS}⁽¹⁾=6, N_{RB}⁽²⁾=9, N_{RB}⁽¹⁾=6, c=3, Δ_{shift}^{PUCCH}=2, n_{PUCCH}⁽¹⁾=27, and tᵢ=200, the UE calculates the virtual resource index n_{PUCCH,t}_{ᵢ}⁽¹⁾ as follows:

m=mₜ_{₀}−N_{RB}⁽²⁾=2,

n_{c}⁽¹⁾=n_{PUCCH}⁽¹⁾−(cN_{SC}^{RB}/Δ_{shift}^{PUCCH})└m′/2┘=9,

n_{PUCCH,t}_{ᵢ}⁽¹⁾=(n_{c}⁽¹⁾+tᵢ)mod Y_{(F)}=209 mod 63=20, equations (22)

where Y_{(F)} is a total number of the resource indexes for the ACK/NACK transmission that correspond to the RBs having an odd-number index. The UE further determines the RB, the cyclic shift sequence, and the orthogonal cover sequence based on the virtual resource index n_{PUCCH,t}_{ᵢ}⁽¹⁾=20, and the predetermined functions θ, ν, and ρ or the table 1406. The UE then performs the ACK/NACK transmission based on the determined RB, the determined cyclic shift sequence, and the determined orthogonal cover sequence, e.g., using the method 500 (FIG. 5).

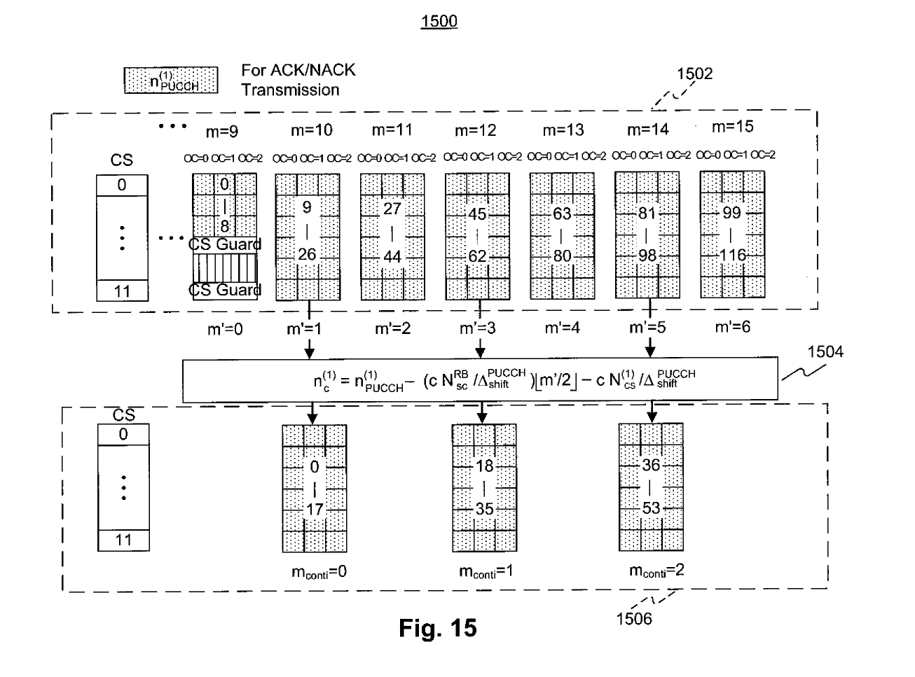

In one exemplary embodiment, in accordance with the method 1500 shown in FIG. 15, a lookup table 1502 is configured by the base station and provided by the base station to the UE. The lookup table 1502 maps each of a plurality of resource indexes to one of the RBs allocated for the PUCCH, one of the plurality of cyclic shift sequences, and one of the plurality of orthogonal cover sequences. For example, the resource indexes 0-116 are used for the ACK/NACK transmission.

The base station assigns to the UE a resource index n_{PUCCH}⁽¹⁾ in the lookup table 1502. Based on the lookup table 1502, the UE maps the assigned resource index n_{PUCCH}⁽¹⁾ to an initial RB with an index mₜ_{₀}. In the exemplary embodiment, the index mₜ_{₀} for the initial RB is an even number, and the index for the mixed-format RB is an odd number.

The UE also revises the assigned resource index n_{PUCCH}⁽¹⁾ to generate a revised resource index n_{c}⁽¹⁾ (1504). For different values of the assigned resource index n_{PUCCH}⁽¹⁾ that correspond to the RBs having an even-number index, i.e., the RBs with m=10, 12, and 14, corresponding values of the revised resource index n_{c}⁽¹⁾ are shown in a table 1506. For example, the revised resource index n_{c}⁽¹⁾ may be generated according to equations (18).

Similar to the above description provided for the method 1300, the UE then calculates a virtual resource index n_{PUCCH,t}_{ᵢ}⁽¹⁾ at a system time tᵢ, and uses the virtual resource index n_{PUCCH,t}_{ᵢ}⁽¹⁾ to further determine an RB from the RBs allocated for the PUCCH, a cyclic shift sequence from the plurality of cyclic shift sequences, and an orthogonal cover sequence from the plurality of orthogonal cover sequences based on the predetermined functions θ, ν, and ρ. Alternatively, the UE may directly determine the RB, the cyclic shift sequence, and the orthogonal cover sequence by looking up in the table 1506 the virtual resource index n_{PUCCH,t}_{ᵢ}⁽¹⁾.

For example, if NC_{CS}⁽¹⁾=6, N_{RB}⁽²⁾=9, N_{RB}⁽¹⁾=6, c=3, Δ_{shift}^{PUCCH}=2, n_{PUCCH}⁽¹⁾=83, and tᵢ=200, the UE calculates the virtual resource index n_{PUCCH,t}_{ᵢ}⁽¹⁾ as follows:

m′=mₜ_{₀}−N_{RB}⁽²⁾=5,

n_{c}⁽¹⁾=n_{PUCCH}⁽¹⁾−(cN_{SC}^{RB}/Δ_{shift}^{PUCCH})└m′/2┘=38,

n_{PUCCH,t}_{ᵢ}⁽¹⁾=(n_{c}⁽¹⁾+tᵢ)mod Y_{(G)}=238 mod 54=22, equations (23)

where Y_{(G)} is a total number of the resource indexes for the ACK/NACK transmission that correspond to the RBs having an even-number index. The UE further determines the RB, the cyclic shift sequence, and the orthogonal cover sequence based on the virtual resource index n_{PUCCH,t}_{ᵢ}⁽¹⁾=22, and the predetermined functions θ, ν, and ρ or the table 1506. The UE then performs the ACK/NACK transmission based on the determined RB, the determined cyclic shift sequence, and the determined orthogonal cover sequence, e.g., using the method 500 (FIG. 5).

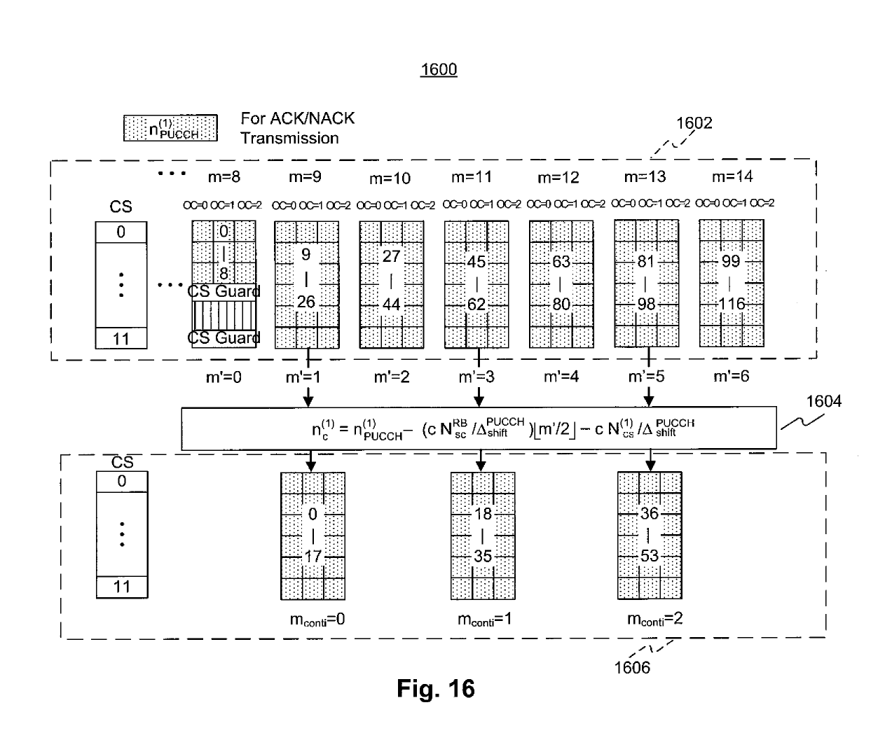

In one exemplary embodiment, in accordance with the method 1600 shown in FIG. 16, a lookup table 1602 is configured by the base station and provided by the base station to the UE. The lookup table 1602 maps each of a plurality of resource indexes to one of the RBs allocated for the PUCCH, one of the plurality of cyclic shift sequences, and one of the plurality of orthogonal cover sequences. For example, the resource indexes 0-116 are used for the ACK/NACK transmission.

The base station assigns to the UE a resource index n_{PUCCH}⁽¹⁾ in the lookup table 1602. Based on the lookup table 1602, the UE maps the assigned resource index n_{PUCCH}⁽¹⁾ to an initial RB with an index mₜ_{₀}. In the exemplary embodiment, the index mₜ_{₀} for the initial RB is an odd number, and the index for the mixed-format RB is an even number.

The UE also revises the assigned resource index n_{PUCCH}⁽¹⁾ to generate a revised resource index n_{c}⁽¹⁾ (1604). For different values of the assigned resource index n_{PUCCH}⁽¹⁾ that correspond to the RBs having an odd-number index, i.e., the RBs with m=9, 11, and 13, corresponding values of the revised resource index n_{c}⁽¹⁾ are shown in a table 1606. For example, the revised resource index n_{c}⁽¹⁾ may be generated according to equations (18).

Similar to the above description provided for the method 1300, the UE then calculates a virtual resource index n_{PUCCH,t}_{ᵢ}⁽¹⁾ at a system time tᵢ, and uses the virtual resource index n_{PUCCH,t}_{ᵢ}⁽¹⁾ to further determine an RB from the RBs allocated for the PUCCH, a cyclic shift sequence from the plurality of cyclic shift sequences, and an orthogonal cover sequence from the plurality of orthogonal cover sequences based on the predetermined functions θ, ν, and ρ. Alternatively, the UE may directly determine the RB, the cyclic shift sequence, and the orthogonal cover sequence by looking up in the table 1606 the virtual resource index n_{PUCCH,t}_{ᵢ}⁽¹⁾.

For example, if N_{CS}⁽¹⁾=6, N_{RB}⁽²⁾=8, N_{RB}⁽¹⁾=6, c=3, Δ_{shift}^{PUCCH}=2, n_{PUCCH}⁽¹⁾=62, and tᵢ=200, the UE calculates the virtual resource index n_{PUCCH,t}_{ᵢ}⁽¹⁾ as follows:

m′=mₜ_{₀}−N_{RB}⁽²⁾=3,

n_{c}⁽¹⁾=n_{PUCCH}⁽¹⁾−(cN_{SC}^{RB}/Δ_{shift}^{PUCCH})└m′/2┘−cN_{CS}⁽¹⁾/Δ_{shift}^{PUCCH}=35,

n_{PUCCH,t}_{ᵢ}⁽¹⁾=(n_{c}⁽¹⁾+tᵢ)mod Y_{(H)}=235 mod 54=19, equations (24)

where Y_{(H)} is a total number of the resource indexes for the ACK/NACK transmission that correspond to the RBs having an odd-number index. The UE further determines the RB, the cyclic shift sequence, and the orthogonal cover sequence based on the virtual resource index n_{PUCCH,t}_{ᵢ}⁽¹⁾=19, and the predetermined functions θ, ν, and ρ or the table 1606. The UE then performs the ACK/NACK transmission based on the determined RB, the determined cyclic shift sequence, and the determined orthogonal cover sequence, e.g., using the method 500 (FIG. 5).

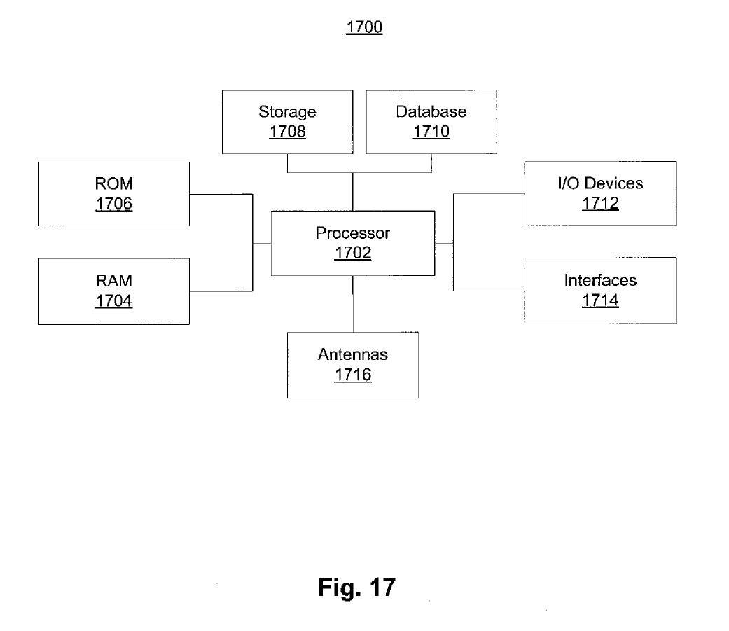

FIG. 17 illustrates a block diagram of a UE 1700, according to an exemplary embodiment. For example, the UE 1700 may be any of the UEs in the above-described communication system. Referring to FIG. 17, the UE 1700 may include one or more of the following components: a processor 1702 configured to execute computer program instructions to perform various processes and methods, random access memory (RAM) 1704 and read only memory (ROM) 1706 configured to access and store information and computer program instructions, storage 1708 to store data and information, databases 1710 to store lookup tables, lists, or other data structures, I/O devices 1712, interfaces 1714, antennas 1716, etc. Each of these components is well-known in the art and will not be discussed further.

While embodiments have been described based on a UE operating according to the LTE standard, the invention is not so limited. It may be practiced with equal effectiveness with any UE transmitting uplink control information.

Other embodiments of the invention will be apparent to those skilled in the art from consideration of the specification and practice of the invention disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a user equipment to transmit uplink control information to a base station, the base station being configured to receive uplink control information on a plurality of groups of subcarriers, the method comprising:
randomly determining one of the groups of subcarriers; and
transmitting uplink control information on the randomly determined group of subcarriers.

2. The method of claim 1, wherein the determining further comprises:
determining the one of the groups of subcarriers based on an assigned resource index.

3. The method of claim 2, wherein the determining based on the assigned resource index further comprises:
calculating a virtual resource index based on the assigned resource index; and
determining the one of the groups of subcarriers based on the calculated virtual resource index.

4. The method of claim 1, wherein the determining further comprises:
determining the one of the groups of subcarriers based on a system time.

5. The method of claim 1, wherein the determining further comprises:
determining the one of the groups of subcarriers based on a lookup table.

6. The method of claim 1, further comprising:
determining ones of the groups of subcarriers periodically; and
transmitting uplink control information on the determined ones of the groups of subcarriers.

7. The method of claim 1, further comprising:
determining ones of the groups of subcarriers aperiodically; and
transmitting uplink control information on the determined ones of the groups of subcarriers.

8. A user equipment to transmit uplink control information to a base station, the base station being configured to receive uplink control information on a plurality of groups of subcarriers, the user equipment comprising:
a processor, the processor being configured to
randomly determine one of the groups of subcarriers, and
transmit uplink control information on the randomly determined group of subcarriers.

9. The user equipment of claim 8, wherein the processor is further configured to:
determine the one of the groups of subcarriers based on a system time.

10. The user equipment of claim 8, wherein the processor is further configured to:
determine the one of the groups of subcarriers based on a lookup table.

11. A method for a user equipment to transmit uplink control information to a base station, the method comprising:
randomly determining a cyclic shift sequence from a plurality of cyclic shift sequences; and
multiplying data bits representing the uplink control information with the randomly selected cyclic shift sequence to generate a signal including the uplink control information.

12. The method of claim 11, wherein the determining of the cyclic shift sequence further comprises:
determining the cyclic shift sequence based on a system time.

13. The method of claim 11, wherein the determining of the cyclic shift sequence further comprises:
determining the cyclic shift sequence based on a lookup table.

14. The method of claim 11, wherein the signal is a first signal, the method further comprising:
randomly determining an orthogonal cover sequence from a plurality of orthogonal cover sequences; and
multiplying the first signal with the randomly determined orthogonal cover sequence to generate a second signal including the uplink control information.

15. The method of claim 14, wherein the determining of the orthogonal cover sequence further comprises:
determining the orthogonal cover sequence based on a system time.

16. The method of claim 14, wherein the determining of the orthogonal cover sequence further comprises:
determining the orthogonal cover sequence based on a lookup table.

17. A user equipment to transmit uplink control information to a base station, the user equipment comprising:
a processor, the processor being configured to
randomly determine a cyclic shift sequence from a plurality of cyclic shift sequences, and
multiply data bits representing the uplink control information with the randomly determined cyclic shift sequence to generate a signal including the uplink control information.

18. The user equipment of claim 17, wherein the processor is further configured to:
determine the cyclic shift sequence based on a system time.

19. The user equipment of claim 17, wherein the processor is further configured to:
determine the cyclic shift sequence based on a look-up table.

20. The user equipment of claim 17, wherein the signal is a first signal, the processor being further configured to:
randomly determine an orthogonal cover sequence from a plurality of orthogonal cover sequences; and
multiply the first signal with the randomly determined orthogonal cover sequence to generate a second signal including the uplink control information.

21. The user equipment of claim 20, wherein the processor is further configured to:
determine the orthogonal cover sequence based on a system time.

22. The user equipment of claim 20, wherein the processor is further configured to:
determine the orthogonal cover sequence based on a look-up table.
